(19) United States
(12) Patent Application Publication
(10) Pub. No.: US 2026/0029533 A1
(43) Pub. Date: Jan. 29, 2026

(54) IMAGING LiDAR SYSTEM AND DESIGN METHOD THEREOF

(71) Applicant: HEFEI INSTITUTES OF PHYSICAL SCIENCE, CAS, Hefei (CN)

(72) Inventors: Zhenzhu WANG, Hefei (CN); Juan ZHU, Hefei (CN); Xuanhao ZHU, Hefei (CN); Zhisheng ZHANG, Hefei (CN); Qian DENG, Hefei (CN); Dong LIU, Hefei (CN)

(73) Assignee: HEFEI INSTITUTES OF PHYSICAL SCIENCE, CAS, Hefei (CN)

(21) Appl. No.: 18/923,283

(22) Filed: Oct. 22, 2024

(30) Foreign Application Priority Data
Jul. 29, 2024 (CN) 202411019806.5

(51) Int. Cl. G01S 17/89; G01S 7/481

(52) U.S. Cl. CPC G01S 17/89; G01S 7/4814; G01S 7/4816; G01S 7/4817

(57) ABSTRACT

Provided are an imaging light detection and ranging (LiDAR) system and a design method thereof. The imaging LiDAR system includes a laser-emitting device and a laser-receiving device that conform to the principle of Scheimpflug imaging, and the laser-receiving device includes a plurality of laser-receiving units. The design method includes: acquiring a minimum detection range of a target laser-receiving unit; when a difference between the minimum detection range and a target minimum detection range is greater than a first set value, arranging a laser-receiving unit adjacent to the target laser-receiving unit; and taking the adjacent laser-receiving unit as a target laser-receiving unit, and repeating the above step to obtain a minimum detection range of the target laser-receiving unit until a laser-receiving unit with a minimum detection range that has a difference less than the first set value from the target minimum detection range is obtained.

### CROSS REFERENCE TO RELATED APPLICATION

This patent application claims the benefit and priority of Chinese Patent Application No. 2024110198065, filed with the China National Intellectual Property Administration on Jul. 29, 2024, the disclosure of which is incorporated by reference herein in its entirety as part of the present application.

### TECHNICAL FIELD

The present disclosure belongs to the technical field of light detection and ranging (LiDAR), and in particular relates to an imaging LiDAR system and a design method thereof.

### BACKGROUND

During production processes of industrial parks, some industrial waste gases and combustion smokes are inevitably emitted, which enter the atmosphere to produce aerosols suspended in the air. The excessive emission of these wastes will have a negative impact on the atmospheric environment and may even affect the health of residents near industrial parks. Therefore, the real-time monitoring of the atmospheric environment in an industrial park can not only protect the lives and health of residents near the industrial park, but also promote the sustainable development of the ecological environment. As an active optical remote sensing technology, the LiDAR technology is an effective means to monitor the spatial and temporal distribution of atmospheric aerosols. However, the common backscatter-based LiDAR have a large volume and a wide detection range, but a large blind spot. For small and medium-sized industrial parks, a too-large blind spot will make it impossible to completely monitor the spatial distribution of aerosols in the entire park. The large volume results in inconvenient movement and a high cost for the backscatter-based LiDAR.

As a result, the portable Scheimpflug imaging LiDAR based on the principle of Scheimpflug imaging is proposed by researchers. A structure of the Scheimpflug imaging LiDAR requires that a plane where a receiving optical system is located, an image plane, and a plane where a laser optical path is located intersect at a point. An imaging system with this structure can allow large-aperture and large-depth-of-field imaging. An echo signal of the Scheimpflug imaging LiDAR can be received by the complementary metal-oxide semiconductor (CMOS) detector to obtain a pixel-intensity relationship for a detection signal, then the pixel-intensity relationship is converted into a signal distance-intensity relationship according to a formula, and atmospheric aerosol parameters are calculated with acquired data according to a Scheimpflug LiDAR equation and an inversion algorithm. This system has a variety of simple components, a compact structure, and a low cost, and thus can be used in a wide range of scenarios. However, due to the structure of the Scheimpflug imaging LiDAR itself, a range resolution of the Scheimpflug imaging LiDAR will be significantly reduced with the increase of a detection range, and it is difficult to take into account a high-range-resolution detection in a large range with a small blind spot. The current Scheimpflug LiDAR on the market either have a high accuracy but a limited detection range, or have a wide detection range but a large blind spot and a low long-range resolution.

### SUMMARY

In order to allow a high accuracy and a high range resolution in a large range with a small blind spot, the present disclosure provides a multi-channel scanning imaging light detection and ranging (LiDAR) system. Specific technical solutions are as follows:

A design method of an imaging LiDAR system is provided, where the imaging LiDAR system includes a laser-emitting device and a laser-receiving device that conform to the principle of Scheimpflug imaging, and the laser-receiving device includes a plurality of laser-receiving units; and the design method includes:
taking a first laser-receiving unit as a target laser-receiving unit, and acquiring a minimum detection range of the target laser-receiving unit according to a maximum target detection range Rₘₐₓ of the target laser-receiving unit, a range resolution ΔRₘₐₓ required by the maximum target detection range, and parameters of the target laser-receiving unit;
when a difference between the minimum detection range and a target minimum detection range is greater than a first set value, arranging a laser-receiving unit adjacent to the target laser-receiving unit; and
when a maximum target detection range corresponding to the adjacent laser-receiving unit is greater than the minimum detection range of the target laser-receiving unit, taking the adjacent laser-receiving unit as a target laser-receiving unit, and returning to the step of acquiring a minimum detection range of the target laser-receiving unit according to a maximum target detection range Rₘₐₓ of the target laser-receiving unit, a range resolution ΔRₘₐₓ required by the maximum target detection range, and parameters of the target laser-receiving unit until a laser-receiving unit with a minimum detection range that has a difference less than the first set value from the target minimum detection range is obtained.

Further, the acquiring a minimum detection range of the target laser-receiving unit according to a maximum target detection range Rₘₐₓ of the target laser-receiving unit, a range resolution ΔRₘₐₓ required by the maximum target detection range, and parameters of the target laser-receiving unit includes:
determining a first parameter K according to the maximum target detection range Rₘₐₓ, the range resolution ΔRₘₐₓ required by the maximum target detection range, and the parameters of the target laser-receiving unit;
determining a second parameter Q according to the first parameter K and the maximum target detection range Rₘₐₓ; and
acquiring a first relationship between a detection range and a pixel according to the first parameter K, the second parameter Q, and the parameters of the target laser-receiving unit, and acquiring the minimum detection range according to the first relationship.

Further, after the first relationship between the detection range and the pixel is acquired according to the first parameter K, the second parameter Q, and the parameters of the target laser-receiving unit, the method further includes:
acquiring a range resolution of a corresponding pixel in the target laser-receiving unit according to the first parameter and the first relationship.

Further, before or after the first relationship between the detection range and the pixel is acquired according to the first parameter K, the second parameter Q, and the parameters of the target laser-receiving unit and the minimum detection range is acquired according to the first relationship, the method further includes:
acquiring a target range R₀ corresponding to a central pixel according to the first relationship; and
according to the target range R₀ corresponding to the central pixel and a distance L from an intersection point to a center of a lens, acquiring an included angle β between a laser optical path in the target laser-receiving unit and a plane where the lens is located.

Further, the parameters of the target laser-receiving unit include: an included angle α between a plane where a lens is located and a receiving plane of an image sensor, an included angle β between a laser optical path and the plane where the lens is located, a distance L from an intersection point to a center of the lens, a focal length f of the lens, a pixel size p of the image sensor, and a number n of pixels; and the intersection point refers to an intersection point among the laser optical path, a center line of the plane where the lens is located, and the corresponding receiving plane of the image sensor.

An imaging LiDAR system designed by the design method of an imaging LiDAR system described above is provided, where the laser-emitting device is configured to emit a laser beam and interact with atmospheric molecules and aerosols to produce a laser optical path; the laser-receiving device includes the plurality of laser-receiving units, and is configured to detect atmospheric echo signals at different heights in an atmosphere; and there is an intersection between detection height ranges of two adjacent laser-receiving units.

Further, the plurality of laser-receiving units each includes:
an image sensor configured to produce an image from a light beam penetrating through a lens; and
a band pass filter arranged between the lens and the image sensor and configured to reduce an impact of background light on a laser scattering signal.

Further, image sensors in the plurality of laser-receiving units are fixed on different holders.

Further, the imaging LiDAR system further includes a scanning base configured to support the laser-emitting device and the laser-receiving device, where the scanning base is able to rotate in a plane direction.

Further, the imaging LiDAR system further includes a signal processing and control device, where the signal processing and control device is connected with the laser-emitting device and the plurality of laser-receiving units, and is configured to control the laser-emitting device to emit a laser and to process signals acquired by the plurality of laser-receiving units.

The present disclosure has the following advantage: In the present disclosure, an imaging LiDAR system that conforms to the principle of Scheimpflug imaging and includes a plurality of laser-receiving units is established to allow high-resolution detection in a large range with a small blind spot. When the maximum target detection range of the next channel is greater than the minimum detection range of the previous channel, it indicates that there is an intersection between detection ranges of the corresponding two adjacent laser-receiving units, which allows the uninterrupted high-resolution detection in a large range with a small blind spot.

### BRIEF DESCRIPTION OF THE DRAWINGS

FIG. 1 is a schematic diagram of a structure of a three-channel Scheimpflug imaging LiDAR system including three laser-receiving units;

FIG. 2 is a flow chart of parameter calculation for the three-channel scanning Scheimpflug imaging LiDAR system; and

FIG. 3 shows target detection range and range resolution data of the three-channel scanning Scheimpflug imaging LiDAR system corresponding to different focal lengths.

### REFERENCE NUMERALS

1: laser; 2: laser optical path-adjusting assembly; 3: first lens; 4: second lens; 5: third lens; 6: first image sensor; 7: second image sensor; 8: third image sensor; 9: signal processing and control device; 10: scanning base; 11: first band pass filter; 12: second band pass filter; and 13: third band pass filter.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are only some rather than all of the embodiments of the present disclosure. All other embodiments obtained by a person skilled in the art based on the embodiments of the present disclosure without creative efforts should fall within the protection scope of the present disclosure. In the description of the embodiments of the present disclosure, it should be understood that the terms such as “first” and “second” are used merely for the purpose of description, and should not be construed as indicating or implying relative importance, or implicitly indicating the number of technical features denoted. Therefore, the features defined by “first” and “second” can explicitly or implicitly include one or more of the features. In the description of the embodiments of the present disclosure, “a plurality of” means two or more, unless otherwise specifically defined.

In an imaging LiDAR system, a detection signal (a laser beam) is emitted by a laser-emitting device to a target, then a signal (a target echo) reflected from the target is compared with the emitted signal by a laser-receiving device, and relevant information about the target can be acquired through appropriate processing, such as a distance, an orientation, a height, a speed, an attitude, and even a shape or the like of the target. In this way, a target such as an aircraft and a missile can be detected, tracked, and identified. The laser-receiving device includes a lens configured to receive a light beam and an image sensor or an image detector configured to produce an image from a light beam penetrating through the lens.

For small and medium-sized industrial parks, a too-large blind spot will make it impossible to completely monitor the spatial distribution of aerosols in the entire park. The imaging LiDAR system has a large volume, resulting in inconvenient movement and a high cost.

With the technical development, the Scheimpflug imaging LiDAR system has been proposed. The Scheimpflug imaging LiDAR system adopts a continuous-wave photodiode laser as a light source and an image sensor as a detector to allow the high-range-resolution detection of atmospheric echo signals under the condition of satisfying the principle of Scheimpflug imaging. Specifically, the Scheimpflug imaging LiDAR system is mainly based on the Scheimpflug principle, which is basically as follows: an object plane, an image plane, and a lens plane intersect in a same straight line, so as to allow the clear imaging within a specified depth of field. In LiDAR, the high-resolution and high-accuracy 3D imaging of a target can be allowed based on this principle. By emitting a laser beam and receiving a reflected signal, information such as a distance and a shape of a target can be accurately acquired based on the principle of Scheimpflug imaging. In this way, the detailed detection and imaging can be conducted for a complicated environment or a specific target.

However, the current Scheimpflug LiDAR on the market has a limited detection range when at a high accuracy, and has a large blind spot and a low range resolution when in a wide detection range.

In order to solve the above problems, as shown in FIG. 2, the present disclosure discloses a design method of an imaging LiDAR system. The imaging LiDAR system includes a laser-emitting device and a laser-receiving device that conform to the principle of Scheimpflug imaging, and the laser-receiving device includes a plurality of laser-receiving units. The design method includes:

A first laser-receiving unit is taken as a target laser-receiving unit, and a minimum detection range of the target laser-receiving unit is acquired according to a maximum target detection range Rₘₐₓ of the target laser-receiving unit, a range resolution ΔRₘₐₓ required by the maximum target detection range, and parameters of the target laser-receiving unit.

When a difference between the minimum detection range and a target minimum detection range is greater than a first set value, a laser-receiving unit adjacent to the target laser-receiving unit is arranged.

When a maximum target detection range corresponding to the adjacent laser-receiving unit is greater than the minimum detection range of the target laser-receiving unit, the adjacent laser-receiving unit is taken as a target laser-receiving unit, and the step of acquiring a minimum detection range of the target laser-receiving unit according to a maximum target detection range Rₘₐₓ of the target laser-receiving unit, a range resolution ΔRₘₐₓ required by the maximum target detection range, and parameters of the target laser-receiving unit is repeated until a laser-receiving unit with a minimum detection range that has a difference less than the first set value from the target minimum detection range is obtained.

In the present disclosure, an imaging LiDAR system that conforms to the principle of Scheimpflug imaging and includes a plurality of laser-receiving units is established to allow high-resolution detection in a large range with a small blind spot. When the maximum target detection range of the next channel is greater than the minimum detection range of the previous channel, it indicates that there is an intersection between detection ranges of the corresponding two adjacent laser-receiving units, which allows the uninterrupted high-resolution detection in a large range with a small blind spot.

In an embodiment, the acquiring a minimum detection range of the target laser-receiving unit according to a maximum target detection range Rₘₐₓ of the target laser-receiving unit, a range resolution ΔRₘₐₓ required by the maximum target detection range, and parameters of the target laser-receiving unit includes:

A first parameter K is determined according to the maximum target detection range Rₘₐₓ, the range resolution ΔRₘₐₓ required by the maximum target detection range, and the parameters of the target laser-receiving unit.

In an embodiment, the parameters of the target laser-receiving unit include: an included angle α between a plane where a lens is located and a receiving plane of an image sensor, an included angle β between a laser optical path and the plane where the lens is located, a distance L from an intersection point to a center of the lens, a focal length f of the lens, a pixel size p of the image sensor, and a number n of pixels; and the intersection point refers to an intersection point among the laser optical path, a center line of the plane where the lens is located, and the corresponding receiving plane of the image sensor.

Similarly, parameters of a second laser-receiving unit include: an included angle α between a plane where a second lens is located and a receiving plane of a second image sensor, an included angle β between a laser optical path and the plane where the second lens is located, a distance L from a second intersection point to a center of the second lens, a focal length f of the second lens, a pixel size p of the second image sensor, and a number n of pixels; and the second intersection point refers to an intersection point among the laser optical path, a center line of the plane where the second lens is located, and the corresponding receiving plane of the second image sensor. Other laser-receiving units also have similar parameters. When the second laser-receiving unit is taken as a new target laser-receiving unit, the parameters of the second laser-receiving unit as the target laser-receiving unit are also calculated to obtain a minimum detection range corresponding to the second laser-receiving unit.

In an embodiment, a formula for determining the first parameter K is as follows:

$$K = \frac{{R}_{max}^{2}}{Δ {R}_{max}} = \frac{fL}{p cos α}$$

A second parameter Q is determined according to the first parameter K and the maximum target detection range Rₘₐₓ:

$$Q = \frac{K}{{R}_{max}} .$$

A first relationship between a detection range and a pixel is acquired according to the first parameter K, the second parameter Q, and the parameters of the target laser-receiving unit, and the minimum detection range is acquired according to the first relationship.

In an embodiment, the first relationship is as follows:

$${R}_{i} = \frac{K}{Q + n - i}$$

where i represents the ith pixel.

The minimum detection range is acquired according to the first relationship as follows:

$${R}_{min} = \frac{K}{Q + n} .$$

In an embodiment, after the first relationship between the detection range and the pixel is acquired according to the first parameter K, the second parameter Q, and the parameters of the target laser-receiving unit, the method further includes:

A range resolution of a corresponding pixel in the target laser-receiving unit is acquired according to the first parameter and the first relationship.

In an embodiment, the range resolution of the corresponding pixel in the target laser-receiving unit is acquired as follows:

$$Δ {R}_{i} = \frac{{R}_{i}^{2}}{K} .$$

In an embodiment, before or after the first relationship between the detection range and the pixel is acquired according to the first parameter K, the second parameter Q, and the parameters of the target laser-receiving unit and the minimum detection range is acquired according to the first relationship, the method further includes: A target range R₀ corresponding to a central pixel is acquired according to the first relationship. A formula for acquiring the target range R₀ corresponding to the central pixel according to the first relationship is as follows:

$${R}_{0} = \frac{K}{Q + n / 2} .$$

In order to determine a position of a lens in the target laser-receiving unit, the present disclosure also discloses the following technical solution: After the target range R₀ corresponding to the central pixel is acquired according to the first relationship, the method further includes:

According to the target range R₀ corresponding to the central pixel and a distance L from an intersection point to a center of the lens, an included angle β between a laser optical path in the target laser-receiving unit and a plane where the lens is located is acquired.

A formula for acquiring the included angle β between the laser optical path in the target laser-receiving unit and the plane where the lens is located is as follows:

$$β = {cos}^{- 1} \frac{L}{{R}_{0}} .$$

Based on the included angle β between the laser optical path and the plane where the lens is located and the above parameters, a specific structure of the imaging LiDAR system can be determined.

In an embodiment, a laser 1 in the laser-emitting device is a low-power continuous-wave diode laser with a wavelength of 532 nm, which has a low price, strong scattered light, and excellent safety.

In an embodiment, a maximum target detection range Rₘₐₓ and a range resolution ΔRₘₐₓ required by the maximum target detection range Rₘₐₓ of the system are determined for a usage scenario. A formula for determining the range resolution is as follows:

$$Δ {R}_{max} = \frac{{R}_{max}^{2}}{k} ⇒ k = \frac{{R}_{max}^{2}}{Δ {R}_{max}} = \frac{fL}{p cos α} .$$

In order to facilitate the calculation of experimental parameters and the aesthetics of the structure of the system, α=45° is selected, and L≈f can be obtained according to the structural relationship, such that cos α=\sqrt{2}/2.

In this usage scenario, the maximum target detection range Rₘₐₓ is 500 m, and ΔRₘₐₓ≤0.4 m, where image sensors all are industrial area-array cameras, a pixel size is 3.45 μm×3.45 μm, and a resolution is 1440×1080. That is, a pixel size p is 3.45 μm, and n is 1,440.

In order to satisfy the above relationship, the above values are substituted into the formula

$$f \geq \frac{{R}_{max}^{2}}{Δ {R}_{max}} p cos α = 390.44 mm .$$

Therefore, a focal length of the first lens 3 in the first laser-receiving unit is determined as 400 mm. Similarly, a focal length of the second lens 4 in the second laser-receiving unit is determined as 200 mm, and a focal length of a third lens 5 in a third laser-receiving unit is determined as 100 mm. Under an action of the three laser-receiving units, ΔRₘₐₓ corresponding to the third laser-receiving unit is less than or equal to 0.4 m.

For the first laser-receiving unit, a maximum detection range Rmax₁ is 500 m, a focal length f₁ of the first lens 3 is 400 mm, it is calculated that corresponding k₁=65586.7, Q₁=131.2, Rmin₁=41.7 m, and β₁=89.7°, and a range resolution ΔR₁ in this range is 0.026 m to 3.8 m.

For the second laser-receiving unit, a maximum detection range Rmax₂ is 42 m, a focal length f₂ of the second lens 4 is 200 mm, it is calculated that k₂=16,396.7, Q₂=390.4, Rmin₂=8.9 m, and β₂=89.2°, and a range resolution ΔR₂ in this range is 0.0048 m to 0.107 m.

For the third laser-receiving unit, a maximum detection range Rmax₃ is 9 m, a focal length f of the third lens 5 is 100 mm, it is calculated that k₃=4,099.2, Q₃=455.4, Rmin₃=2.1 m, and β₃=88.3°, and a range resolution ΔR₃ in this range is 0.0011 m to 0.019 m.

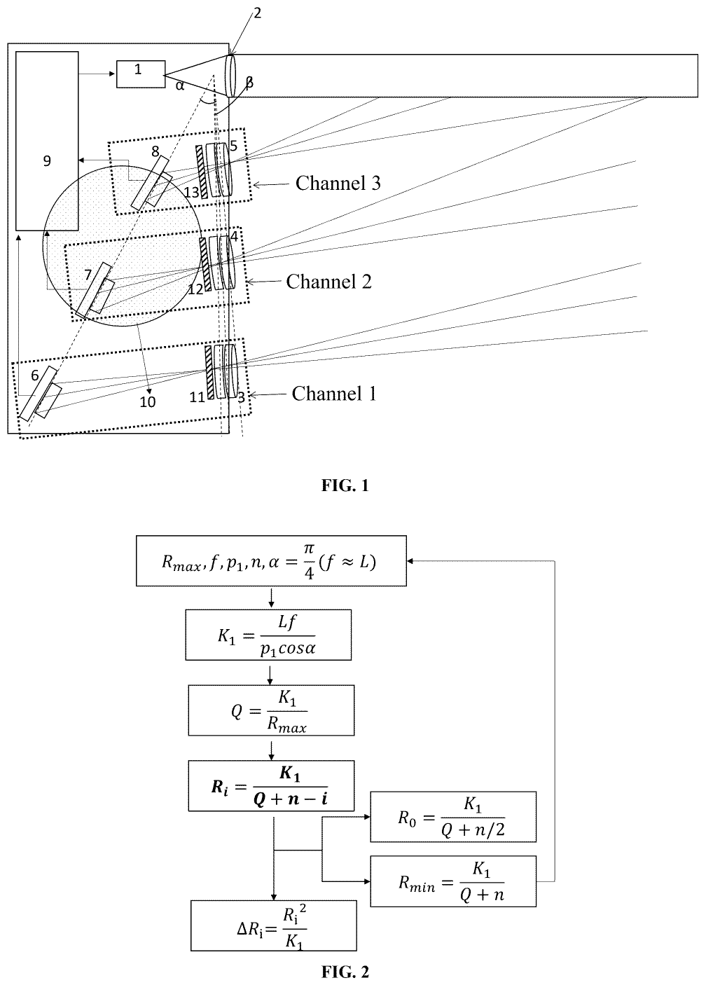

The above-mentioned imaging LiDAR system for industrial pollution monitoring adopts the three laser-receiving units, and thus is a three-channel scanning Scheimpflug imaging LiDAR system, as shown in FIG. 1. As shown in FIG. 1, the three channels are denoted as a channel 1, a channel 2, and a channel 3 sequentially away from a Scheimpflug imaging intersection point. The focal lengths of the first lens 3, the second lens 4, and the third lens 5 decrease sequentially.

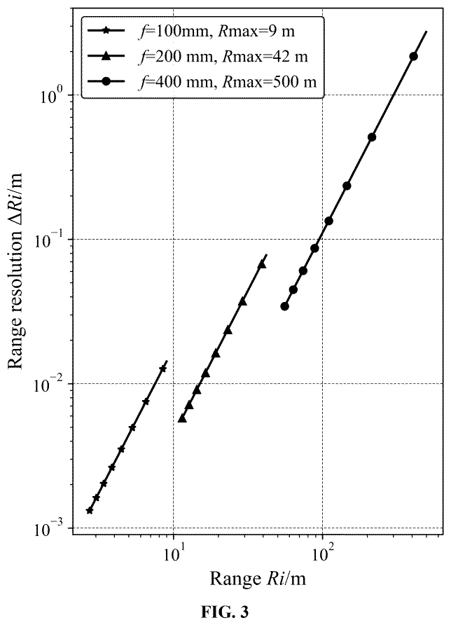

Based on data measured by the above method, it can be known that a detection range is 2.1 m to 500 m and a change range of a range resolution ΔR is 1.1 mm (2.1 m) to 3.8 m (500 m), and target detection range and range resolution data of the three-channel scanning Scheimpflug imaging LiDAR system corresponding to different focal lengths shown in FIG. 3 is obtained. Theoretically, there are 1,440 dots (representing 1,440 pixels) on each straight line. However, in order to make an image intuitive and clear, it is marked once every 200 pixels, and thus there are 8 dots. Compared with a single-channel system, the three-channel system has a small blind spot and an improved range resolution at a long range.

In a practical application, two, four, or other numbers of laser-receiving units can also be provided. However, based on this specific case, if two channels are adopted, a blind spot of detection and a range resolution cannot be well taken into account, and if four channels are adopted, a corresponding system will be redundant. In other specific embodiments, a number of channels can be adjusted according to a specific case, and any number of channels can fall within the protection scope of the present disclosure.

In another embodiment, the present disclosure also discloses an imaging LiDAR system designed by the design method described above. The laser-emitting device is configured to emit a laser beam and interact with atmospheric molecules and aerosols to produce a laser optical path. The laser-receiving device includes the plurality of laser-receiving units, and is configured to detect atmospheric echo signals at different heights in an atmosphere. There is an intersection between detection height ranges of two adjacent laser-receiving units.

In this embodiment, by arranging the plurality of laser-receiving units and allowing the intersection between detection height ranges of two adjacent laser-receiving units, the system can allow the excellent range resolution at a long range with a small blind spot, and can also ensure the continuity of detection.

In an embodiment, the laser-emitting device includes a laser 1 and a laser optical path-adjusting assembly 2 arranged behind the laser 1. The laser 1 is a continuous-wave diode laser that is cheap and has many selectable wavelengths. The laser optical path-adjusting assembly 2 includes a collimating lens and a beam expander, and is configured to allow collimation and beam expansion for a laser emitted by the laser 1 and then emit a resulting laser to an open region. The beam expander is a lens assembly capable of changing a diameter and a divergence angle of a laser beam, and the beam expander also has a collimating function. In this embodiment, a laser beam emitted by the laser has a specified divergence angle, the laser beam is adjusted into a collimated laser beam by the beam expander, and a diameter of the collimated laser beam remains basically unchanged on an air transmission path. The laser undergoes a scattering effect with aerosol particles in the atmosphere on an optical path, and a scattering signal reflected back will be recorded by a laser-receiving unit. When an aerosol concentration in a park changes, an aerosol scattering intensity received by a laser-receiving unit will also change, and a spatial and temporal distribution of aerosols in the park can be obtained through data inversion.

The imaging system further includes a three-channel imaging system arranged from a center of a target laser imaging lens to a Scheimpflug imaging intersection point, and a distance from the center of the target laser imaging lens to the Scheimpflug imaging intersection point is approximately equal to a focal length of the target laser imaging lens. The three-channel imaging system is fixed through a holder, and is configured to receive an aerosol scattering signal reflected.

In an embodiment, the laser-receiving unit further includes a band pass filter and an image sensor. The image sensor is configured to produce an image from a light beam penetrating through the lens. The band pass filter is arranged between the lens and the image sensor and configured to reduce an impact of background light on a laser scattering signal. In an embodiment, three band pass filters in the three laser-receiving units are a first band pass filter 11, a second band pass filter 12, and a third band pass filter 13, respectively. The first band pass filter 11, the second band pass filter 12, and the third band pass filter 13 each have a center wavelength of 532 nm and a half-wave bandwidth of 10 nm. These band pass filters only allow light with a wavelength of 512 nm to 552 nm to pass through, and can also block an undesired part of a spectrum. The above selective transmission can reduce an impact of background light on a laser scattering signal to improve a signal-to-noise ratio of the laser scattering signal.

A lens in the laser-receiving unit is an achromatic doublet lens. The achromatic doublet lens exhibits an improved light transmittance compared with the ordinary lens. Therefore, the achromatic doublet lens makes light easy to pass through and can well focus light, which reduces the light scattering and distortion to improve an imaging quality.

Based on the three-channel scanning Scheimpflug imaging LiDAR system shown in FIG. 1, a maximum difference among the three β₁, β₂, and β₃ is 1.4°. Image sensors in the plurality of laser-receiving units are fixed on different holders. A β angle difference between different laser-receiving units can be compensated by adjusting the image sensors on different holders. Structures of the holders are adjustable, which is convenient for the debugging of each component in the system.

In an embodiment, the system further includes a scanning base 10 configured to support the laser-receiving device. The scanning base 10 can rotate horizontally in a plane direction. Due to the arrangement of the scanning base 10, after the scanning base 10 rotates for one week, a measurement cycle ends, and a spatial and temporal distribution of aerosols under an observation radius of 500 m in a park is obtained.

In an embodiment, the system further includes a box, and the laser-emitting device and the laser-receiving device both are arranged in the box. The box is opaque. In an embodiment, the box is a black rectangular box, which can reduce the interference of stray light and background light during imaging. In addition, the arrangement of the box is equivalent to the encapsulation of the laser-emitting device and the laser-receiving device, which is convenient for moving and carrying.

In an embodiment, the system further includes a signal processing and control device 9. The signal processing and control device is connected with the laser-emitting device and the plurality of laser-receiving units, and is configured to control the laser-emitting device to emit a laser and to process signals acquired by the plurality of laser-receiving units. The signal processing and control device 9 is configured to control the laser emission of the laser-emitting device and the shooting and storage of the image sensor. In an embodiment, the software implementation of the signal processing and control device is developed by the visual C#language. The laser-emitting device is connected with a first image sensor 6, a second image sensor 7, and a third image sensor 8 through USB data cables.

In an embodiment, the signal processing and control device 9 is also connected with a controlled end of the scanning base 10, and is configured to control a rotation rate of the scanning base 10 to make the rotation rate match with a shooting frequency of an image sensor in the system.

In an embodiment, the signal processing and control device 9 further includes image data storage, background noise removal, data extraction and conversion, and backscattering coefficient inversion. The signal processing and control device 9 is responsible for extracting a laser scattering signal in a shot image. The acquired data is inverted according to a LiDAR equation and an inversion algorithm, and an inversion result is transmitted to a background monitoring system.

In an embodiment, the imaging LiDAR system can work automatically and continuously under unattended conditions. A component position is adjusted, the initial parameters are set, and the picture data recorded by the system is saved in a chronological order. The sky brightness varies throughout the day, with a maximum light intensity at noon and a minimum light intensity at night. When the same exposure time and gain are adopted, a signal intensity in an image sensor will be saturated or too weak. Therefore, the three image sensors require automatic exposure and gain adjustments according to background noises at different time points. After the setting is completed, a scattering signal on a laser path will be captured and saved in a designated folder, and then the data processing and inversion are conducted to obtain an aerosol change in a park that is continuously detected around the clock.

A working process of the above-mentioned imaging LiDAR system is as follows:

A three-channel scanning Scheimpflug imaging LiDAR system for industrial pollution monitoring works as follows:

A power supply is turned on. It is checked whether interfaces of an industrial area-array camera and the laser 1 are connected and powered on normally. A switch button is started to first enter a set mode. In the set mode, a switching frequency of the laser-emitting device, a shooting frequency of the image sensor, and a rotation frequency of the scanning base 10 are set according to actual needs. According to a background environment of the day, the system automatically adjusts an intensity of an emitted laser and an exposure time and gain of the industrial area-array camera to ensure a clear shot picture. The scanning base 10 rotates 360° at a specified frequency to allow scanning detection. The image data acquired by the image sensor is processed by the signal processing and control device 9. A scattering signal on a laser optical path is extracted by the signal processing and control device 9 and converted into a range-intensity signal according to a formula, and the data inversion is conducted. In a background monitoring system, the change characteristics of a backscattering coefficient of atmospheric aerosols in a park can be observed in real time, which is convenient for staff to monitor and track a pollution source in the park.

In the present disclosure, corresponding system parameters are selected according to a scope of an observation region to reduce the unnecessary experimental consumables and manpower. The multi-channel design is adopted to allow a high range resolution at a long range with a small blind spot of the system. The system is integrated into a black box to improve the portability of the system and facilitate the maintenance of the system. Specific positions of components in the system can be calculated according to formulas, and it is easy to adjust a position of each component in the system. In addition, the Scheimpflug imaging LiDAR system is assembled with the scanning base 10 to allow the scanning detection of the system. In summary, the three-channel scanning Scheimpflug imaging LiDAR system for industrial pollution monitoring has a simple detection structure, a low cost, a small blind spot of detection, and a high range resolution.

In the description of the specification, reference to the terms such as “some embodiments” or “examples” means that a specific feature, structure, material, or characteristic described in combination with the embodiment(s) or example(s) are included in at least one embodiment or example of the present disclosure. In this specification, the schematic expression of the above terms is not necessarily directed to the same embodiment or example. In addition, the specific features, structures, materials, or characteristics described may be combined in any suitable manner in any one or more embodiments. In addition, different embodiments or examples described in the specification may be joined and combined by a person skilled in the art.

The above are merely preferred embodiments of the present disclosure, and are not intended to limit the present disclosure in any way. Any form of a variation such as an equivalent replacement or modification made to the technical solutions and technical contents disclosed in the present disclosure by those skilled in the art without departing from the technical solutions of the present disclosure does not deviate from the technical solutions of the present disclosure and still fall within the protection scope of the present disclosure.

What is claimed is:

1. A design method of an imaging light detection and ranging (LiDAR) system, wherein the imaging LiDAR system comprises a laser-emitting device and a laser-receiving device that conform to the principle of Scheimpflug imaging, and the laser-receiving device comprises a plurality of laser-receiving units; and the design method comprises:
taking a first laser-receiving unit as a target laser-receiving unit, and acquiring a minimum detection range of the target laser-receiving unit according to a maximum target detection range Rₘₐₓ of the target laser-receiving unit, a range resolution ΔRₘₐₓ required by the maximum target detection range, and parameters of the target laser-receiving unit;
when a difference between the minimum detection range and a target minimum detection range is greater than a first set value, arranging a laser-receiving unit adjacent to the target laser-receiving unit; and
when a maximum target detection range corresponding to the adjacent laser-receiving unit is greater than the minimum detection range of the target laser-receiving unit, taking the adjacent laser-receiving unit as a target laser-receiving unit, and returning to the step of acquiring a minimum detection range of the target laser-receiving unit according to a maximum target detection range Rₘₐₓ of the target laser-receiving unit, a range resolution ΔRₘₐₓ required by the maximum target detection range, and parameters of the target laser-receiving unit until a laser-receiving unit with a minimum detection range that has a difference less than the first set value from the target minimum detection range is obtained.

2. The design method according to claim 1, wherein the acquiring a minimum detection range of the target laser-receiving unit according to a maximum target detection range Rₘₐₓ of the target laser-receiving unit, a range resolution ΔRₘₐₓ required by the maximum target detection range, and parameters of the target laser-receiving unit comprises:
determining a first parameter K according to the maximum target detection range Rₘₐₓ, the range resolution ΔRₘₐₓ required by the maximum target detection range, and the parameters of the target laser-receiving unit;
determining a second parameter Q according to the first parameter K and the maximum target detection range Rₘₐₓ; and
acquiring a first relationship between a detection range and a pixel according to the first parameter K, the second parameter Q, and the parameters of the target laser-receiving unit, and acquiring the minimum detection range according to the first relationship.

3. The design method according to claim 2, wherein after the first relationship between the detection range and the pixel is acquired according to the first parameter K, the second parameter Q, and the parameters of the target laser-receiving unit, the method further comprises:
acquiring a range resolution of a corresponding pixel in the target laser-receiving unit according to the first parameter and the first relationship.

4. The design method according to claim 2, wherein before or after the first relationship between the detection range and the pixel is acquired according to the first parameter K, the second parameter Q, and the parameters of the target laser-receiving unit and the minimum detection range is acquired according to the first relationship, the method further comprises:
acquiring a target range R₀ corresponding to a central pixel according to the first relationship; and
according to the target range R₀ corresponding to the central pixel and a distance L from an intersection point to a center of a lens, acquiring an included angle β between a laser optical path in the target laser-receiving unit and a plane where the lens is located.

5. The design method according to claim 1, wherein the parameters of the target laser-receiving unit comprise: an included angle α between a plane where a lens is located and a receiving plane of an image sensor, an included angle β between a laser optical path and the plane where the lens is located, a distance L from an intersection point to a center of the lens, a focal length f of the lens, a pixel size p of the image sensor, and a number n of pixels; and the intersection point refers to an intersection point among the laser optical path, a center line of the plane where the lens is located, and the corresponding receiving plane of the image sensor.

6. An imaging LiDAR system designed by the design method of an imaging LiDAR system according to claim 1, wherein the laser-emitting device is configured to emit a laser beam and interact with atmospheric molecules and aerosols to produce a laser optical path; the laser-receiving device comprises the plurality of laser-receiving units, and is configured to detect atmospheric echo signals at different heights in an atmosphere; and there is an intersection between detection height ranges of two adjacent laser-receiving units.

7. The imaging LiDAR system according to claim 6, wherein the plurality of laser-receiving units each comprises:
an image sensor configured to produce an image from a light beam penetrating through a lens; and
a band pass filter arranged between the lens and the image sensor and configured to reduce an impact of background light on a laser scattering signal.

8. The imaging LiDAR system according to claim 6, wherein the image sensors in the plurality of laser-receiving units are fixed on different holders.

9. The imaging LiDAR system according to claim 6, further comprising a scanning base configured to support the laser-emitting device and the laser-receiving device, wherein the scanning base is able to rotate in a plane direction.

10. The imaging LiDAR system according to claim 6, further comprising a signal processing and control device, wherein the signal processing and control device is connected with the laser-emitting device and the plurality of laser-receiving units, and is configured to control the laser-emitting device to emit a laser and to process signals acquired by the plurality of laser-receiving units.

11. The imaging LiDAR system according to claim 6, wherein the acquiring a minimum detection range of the target laser-receiving unit according to a maximum target detection range Rₘₐₓ of the target laser-receiving unit, a range resolution ΔRₘₐₓ required by the maximum target detection range, and parameters of the target laser-receiving unit comprises:
determining a first parameter K according to the maximum target detection range Rₘₐₓ, the range resolution ΔRₘₐₓ required by the maximum target detection range, and the parameters of the target laser-receiving unit;
determining a second parameter Q according to the first parameter K and the maximum target detection range Rₘₐₓ; and
acquiring a first relationship between a detection range and a pixel according to the first parameter K, the second parameter Q, and the parameters of the target laser-receiving unit, and acquiring the minimum detection range according to the first relationship.

12. The imaging LiDAR system according to claim 11, wherein after the first relationship between the detection range and the pixel is acquired according to the first parameter K, the second parameter Q, and the parameters of the target laser-receiving unit, the method further comprises:
acquiring a range resolution of a corresponding pixel in the target laser-receiving unit according to the first parameter and the first relationship.

13. The imaging LiDAR system according to claim 11, wherein before or after the first relationship between the detection range and the pixel is acquired according to the first parameter K, the second parameter Q, and the parameters of the target laser-receiving unit and the minimum detection range is acquired according to the first relationship, the method further comprises:
acquiring a target range R₀ corresponding to a central pixel according to the first relationship; and
according to the target range R₀ corresponding to the central pixel and a distance L from an intersection point to a center of a lens, acquiring an included angle β between a laser optical path in the target laser-receiving unit and a plane where the lens is located.

14. The imaging LiDAR system according to claim 6, wherein the parameters of the target laser-receiving unit comprise: an included angle α between a plane where a lens is located and a receiving plane of an image sensor, an included angle β between a laser optical path and the plane where the lens is located, a distance L from an intersection point to a center of the lens, a focal length f of the lens, a pixel size p of the image sensor, and a number n of pixels; and the intersection point refers to an intersection point among the laser optical path, a center line of the plane where the lens is located, and the corresponding receiving plane of the image sensor.

15. The imaging LiDAR system according to claim 11, wherein the plurality of laser-receiving units each comprises:
an image sensor configured to produce an image from a light beam penetrating through a lens; and
a band pass filter arranged between the lens and the image sensor and configured to reduce an impact of background light on a laser scattering signal.

16. The imaging LiDAR system according to claim 12, wherein the plurality of laser-receiving units each comprises:
an image sensor configured to produce an image from a light beam penetrating through a lens; and
a band pass filter arranged between the lens and the image sensor and configured to reduce an impact of background light on a laser scattering signal.

17. The imaging LiDAR system according to claim 13, wherein the plurality of laser-receiving units each comprises:
an image sensor configured to produce an image from a light beam penetrating through a lens; and
a band pass filter arranged between the lens and the image sensor and configured to reduce an impact of background light on a laser scattering signal.

18. The imaging LiDAR system according to claim 14, wherein the plurality of laser-receiving units each comprises:
an image sensor configured to produce an image from a light beam penetrating through a lens; and
a band pass filter arranged between the lens and the image sensor and configured to reduce an impact of background light on a laser scattering signal.

19. The imaging LiDAR system according to claim 7, wherein the image sensors in the plurality of laser-receiving units are fixed on different holders.

20. The imaging LiDAR system according to claim 11, wherein the image sensors in the plurality of laser-receiving units are fixed on different holders.
